(19) United States
(12) Patent Application Publication
(10) Pub. No.: US 2004/0061470 A1
(43) Pub. Date: Apr. 1, 2004

(54) Brushless motor

(76) Inventors: Makoto Ito, Okazaki-city (JP); Hideo Watanabe, Kariya-city (JP)

Correspondence Address: POSZ & BETHARDS, PLC, 11250 ROGER BACON DRIVE, SUITE 10, RESTON, VA, 20190, US

(21) Appl. No.: 10/614,896

(22) Filed: Jul. 9, 2003

(30) Foreign Application Priority Data
Jul. 26, 2002 (JP) 2002-217835

(51) Int. Cl. G05B 23/02

(52) U.S. Cl. 318/565

(57) ABSTRACT

A brushless motor capable of suppressing noise and vibration resulting from relative positional displacement between a sensor magnet and magnetic sensors caused by assembling errors has a 3-phase brushless motor with a 6-pole sensor magnet rotating integrally with a rotor and hole elements arranged with an angular spacing of 20° (mechanical angle). Position signals are obtained from output signals of the hole elements, with the phases of output signals of one or two hole elements being inverted.

### CROSS REFERENCE TO RELATED APPLICATION

This application is based upon, claims the benefit of priority of, and incorporates by reference, the contents of Japanese Patent Application No. 2002-217835 filed Jul. 26, 2002.

### BACKGROUND OF THE INVENTION

1. Field of the Invention

The present invention relates to a brushless motor having a sensor magnet and magnetic sensors for detecting the rotary position of the motor rotor.

2. Description of the Related Art

Japanese Patent Laid-Open Publication No. Hei 11-356024 shows a brushless motor used as a blower motor for a vehicle air-conditioning system. It has a 6-pole rotor magnet fixed to a yolk and a disk-like 6-pole sensor magnet attached to a lower end of the output shaft. A circuit board is attached in close proximity and is parallel to the bottom face of the sensor magnet. On the circuit board are mounted an excitation circuit for excitation coils, connection terminals corresponding to power supply terminals of the excitation coils, and three hole elements arranged opposite the circumference of the sensor magnet.

FIG. 9 illustrates a prior art construction of the layout of the hole elements. The 6-pole sensor magnet 2 is coupled on the rotary shaft 1, and the hole elements 3w, 3u, and 3v are spaced from each other at an angle of either 40° or 80° around this rotary shaft 1. FIG. 9 shows the latter case. The excitation circuit 4 includes a 3-phase bridge inverter circuit and controls power supply to the excitation coils 5u, 5v, and 5w in accordance with output signals from the hole elements 3u, 3v, and 3w for rotating the rotor.

Because the sensor magnet 2 is attached to the rotary shaft 1 while the hole elements 3u, 3v, and 3w are mounted on the circuit board, which is then attached to a motor holder, there are cases where accumulated assembling errors have some bearing on the positional relationship between the sensor magnet 2 and hole elements 3u, 3v, and 3w.

FIG. 10 shows a state in which there has been a change in relative positions of the sensor magnet 2 and hole elements 3u, 3v, and 3w because of assembling errors. The broken lines indicate the position where the sensor magnet 2 should ideally be located. As can be seen, because of the displacement of the sensor magnet 2 in the X-axis direction on the X-Y coordinate basis in the drawing, the angular distance θ1 between the hole elements 3w and 3u is smaller than 80°, while the angular distance θ2 between the hole elements 3u and 3v is larger than 80°.

FIG. 11 shows the detected magnetic fields of the hole elements 3u, 3v, and 3w in this state and position signals Du, Dv, and Dw together with output states of the inverter circuit included in the excitation circuit 4 and input current in the inverter circuit (combined waveform of three phase currents). As can be seen, the phase difference between the position signals Du, Dv, and Dw, based on which the power supply switching control is performed, is largely shifted from the electrical angle of 120°. Because of this the current in the excitation coils includes a superimposed component having a large phase shift cycle of 180° (electrical angle). This unbalanced phase current causes torque variations, which increase operation noise in a particular frequency band, for example, in a resonance frequency band of 200 Hz to 300 Hz, of the casing in which the motor is assembled, causing an unpleasant feeling to the vehicle occupant.

### SUMMARY OF THE INVENTION

The present invention has been devised in light of the circumstances described above. A first object is to provide a brushless motor capable of suppressing noise and vibration resulting from relative positional displacement between the sensor magnet and magnetic sensors caused by assembling errors and the like.

According to a first aspect of the present invention, the first and third magnetic sensors are arranged with a predetermined angular distance so that they detect a magnetic field of the sensor magnet, which rotates integrally with the rotor in a constant angular relationship with the rotor. The output signals from these magnetic sensors enable detection of the rotary position of the rotor so that the brushless motor is driven based on the detected positions.

Assembling errors or the like during the manufacturing process can cause relative positional displacement between the sensor magnet and magnetic sensors. An analysis has shown that an error Δθ1 of the angular distance θ1 between the first and second magnetic sensors and an error Δθ2 of the angular distance θ2 between the second and third magnetic sensors can be made smaller if the angular distances θ1 and θ2 are small. Meanwhile, to perform power supply switching control, position signals with a 120° phase offset (electrical angle) are necessary.

Accordingly, the angular distances θ1 and θ2 are set to be the smallest possible angles of the angles less than 180° that are θa, 2×θa, 4×θa, 5×θa, 7×θa, 8×θa, 10×θa, 11×θa, . . . , where θa is a basic minimum angle and obtained by 360°/(n•3) (n≧2) (mechanical angle). If it is impossible to arrange the magnetic sensors with the minimum angle because of size limitations of the sensor magnet, then the next smallest angle should be selected.

With this arrangement, the output signals of the magnetic sensors are less affected even if there is a change in relative positions of the sensor magnet and magnetic sensors, whereby variations in the phase currents are reduced, and operation noise and vibration are suppressed. Because there will be less discrepancy in alternating timing, efficiency deterioration can be suppressed. Furthermore, because this arrangement can be achieved by altering the layout of the magnetic sensors, the cost increase is minimal.

According to a second aspect of the invention, phase adjusting means included in the brushless motor generates position signals having a mutual phase difference of 120° (electrical angle), whereby alternating current control is performed using these position signals.

According to a third aspect of the invention, if the angular distance θ1 or θ2 (mechanical angle) is one of θa, 5×θa, 7×θa, 11×θa, and so on, i.e., if it is (6m+3+/−2)×θa (as a mechanical angle), the position signals are obtained by inverting phases of the output signals of the first and third magnetic sensors while the output signal of the second magnetic sensor is used as it is as a position signal. Thereby, position signals with a 120° phase difference (electrical angle) can be obtained. The effects of a fourth aspect of the invention are the same.

According to a fifth aspect of the invention, the phase adjusting means is constructed so that it inverts the phases by reversing the polarity of the signal output terminals of the magnetic sensors, which are hole elements. Therefore, no circuit is necessary for phase adjustment.

According to a sixth aspect of the invention, with the substrate assembled in the system, power is supplied to the excitation coils via the power supply terminals on the substrate, and magnetic sensors on the substrate positioned in close proximity to the sensor magnet detect the magnetic field thereof. Because the magnetic sensors are arranged on the substrate, assembly and component replacement are readily carried out, and adverse effects of assembling errors, which may cause a change in relative positions of the sensor magnet and magnetic sensors, can be suppressed to a minimum.

According to a seventh aspect of the invention, because the control circuit for controlling power to the excitation coils is arranged on the substrate, rotation of the brushless motor can be initiated by merely supplying power thereto.

According to an eighth aspect of the invention, operation noise of the motor inside the vehicle is suppressed, thereby reducing unpleasant feelings for the vehicle occupants.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a schematic representation of the electrical structure of a brushless motor according to a first embodiment of the present invention;

FIG. 2 is an exploded perspective view of the brushless motor;

FIG. 3 is a diagram illustrating relative positions of a sensor magnet and hole elements;

FIG. 4 is a diagram illustrating the relationship between ideal layout angles θ0 and differentiation factors;

FIG. 5 is a waveform chart of a state in which there is no positional displacement between the hole elements and the sensor magnet;

FIG. 6 is a waveform chart of a state in which the sensor magnet has displaced in an X-axis direction relative to the hole elements;

FIG. 7 is a schematic representation of the electrical structure of a brushless motor according to a second embodiment of the present invention, shown in a manner similar to FIG. 1;

FIG. 8 is a schematic representation of the electrical structure of a brushless motor according to a third embodiment of the present invention, shown in a manner similar to FIG. 1;

FIG. 9 is a schematic representation of the electrical structure of a prior art brushless motor;

FIG. 10 is a diagram illustrating relative positions of a sensor magnet and hole elements displaced from each other; and

FIG. 11 is a waveform chart of a state in which the sensor magnet has displaced in the X-axis direction relative to the hole elements, shown in a manner similar to FIG. 6.

### DETAILED DESCRIPTION OF THE PREFERRED EMBODIMENTS

The following description of the preferred embodiments is merely exemplary in nature and is in no way intended to limit the invention, its application, or uses.

### First Embodiment

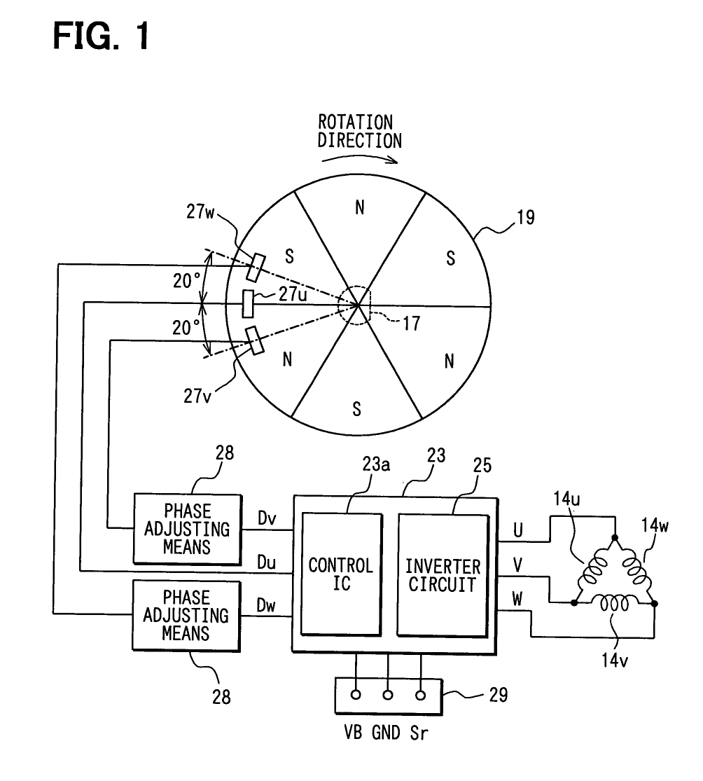

A first embodiment of the present invention will be hereinafter described with reference to FIG. 1 to FIG. 6.

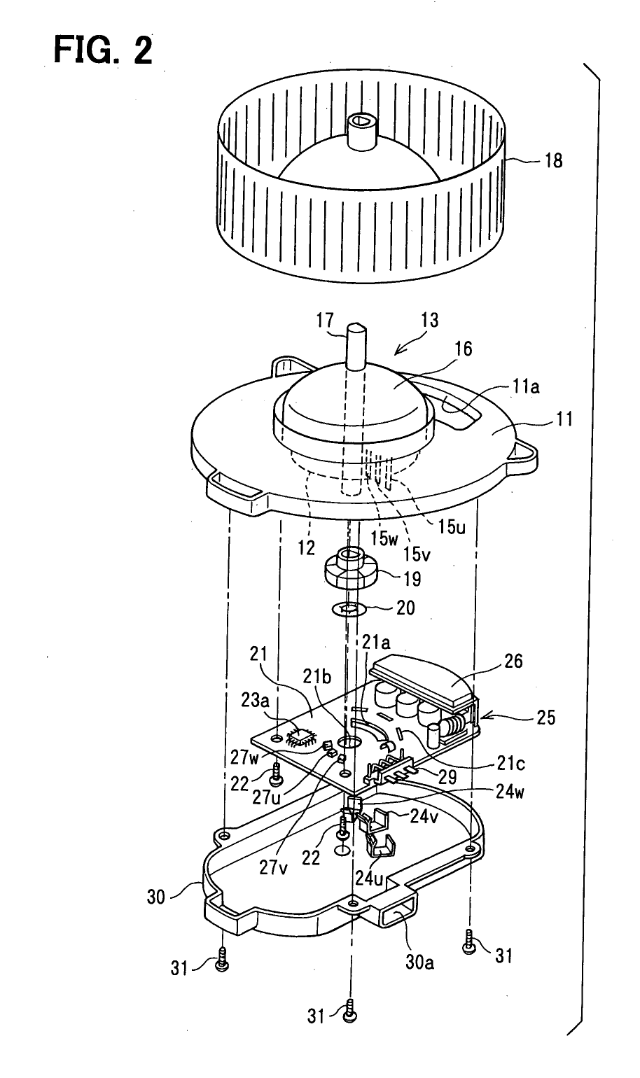

FIG. 2 is an exploded perspective view of a 3-phase brushless motor used as a blower motor of a vehicle air-conditioning system. FIG. 1 provides a schematic representation of the electrical structure of the brushless motor. As shown in FIG. 2, the stator 12 is fixed in a resin motor holder 11, and the rotor 13 is supported by a bearing (not shown) such as to be rotatable relative to the stator 12. Excitation coils 14u, 14v, and 14w (see FIG. 1) of U-phase, V-phase, and W-phase are coiled around the stator core, and respective power supply terminals 15u, 15v, and 15w, connected to each of the excitation coils, are extended downwards.

A 6-pole rotor magnet (not shown) is fixedly attached to an inner face of a rotor yolk 16. A fan 18 is fixed to the top end of an output shaft 17, and a sensor magnet 19 is attached to the bottom end with a clasp 20 for stopping the magnet from coming off the output shaft 17. The sensor magnet 19 has six poles as shown in FIG. 1 as with the rotor magnet, i.e., N and S poles alternate every 60°. The rotor magnet and sensor magnet 19 are assembled so that a constant positional relationship is maintained between their magnetic poles.

Beneath the motor holder 11 is attached a circuit board 21 with screws 22, on which is mounted a power supply control circuit 23 (see FIG. 1) for supplying power to the excitation coils 14u, 14v, and 14w. The circuit board 21 is formed with through holes 21a, 21b, and insertion holes 21c. The power supply terminals 15u, 15v, and 15w pass through the fan-shaped hole 21a, and the output shaft 17 passes through the hole 21b. Base ends of U-shaped connection terminals 24u, 24v, and 24w are fitted in the three insertion holes 21c and act as power supply terminals.

The base ends of the connection terminals 24u, 24v, and 24w are inserted in the insertion holes 21c and soldered so that they are electrically connected to output terminals of each phase in the power supply control circuit 23. To the distal ends of the connection terminals 24u, 24v, and 24w are coupled the distal ends of the power supply terminals 15u, 15v, and 15w, respectively, whereby electrical connection is established between each of the power supply terminals 15u, 15v, and 15w and the circuit board 21.

The power supply control circuit 23 includes a 3-phase bridge inverter circuit 25 that is controlled by a control IC 23a, and the circuit board 21 includes a heat sink 26 for cooling switching elements (not shown) in this inverter circuit 25. The motor holder 11 is formed with an aperture 11a conforming to the shape of the heat sink 26, so that the upper face of the heat sink 26 will fit into the aperture 11a when the circuit board 21 is attached to the motor holder 11 for effective heat dissipation.

The upper face of the circuit board 21 has three hole elements 27v, 27u, and 27w attached in this order in the forward direction of the rotor 13 so that they will be positioned opposite the circumference of the lower face of the sensor magnet 19. The hole elements 27w, 27u, and 27v are termed as “first, second, and third magnetic sensors” in the claims. These hole elements 27v, 27u, and 27w are arranged on an opposite side of the through hole 21b as the through hole 21a and at a mechanical angular spacing of 20° around the output shaft 17 as shown in FIG. 1. Two output terminals of the hole elements 27v and 27w are reversely connected so as to invert the phases of their output signals. A phase adjusting means 28 is thus constructed.

A connector 29 is attached to the circuit board 21 for supplying a battery voltage VB of, for example, 14V, to the power supply control circuit 23 and for applying rpm command signals Sr. The circuit board 21 is covered by a lower case 30 attached to the motor holder 11 by screws 31. The connector 29 is connected to an external harness (not shown) through a hole 30a formed in a side face of the lower case 30.

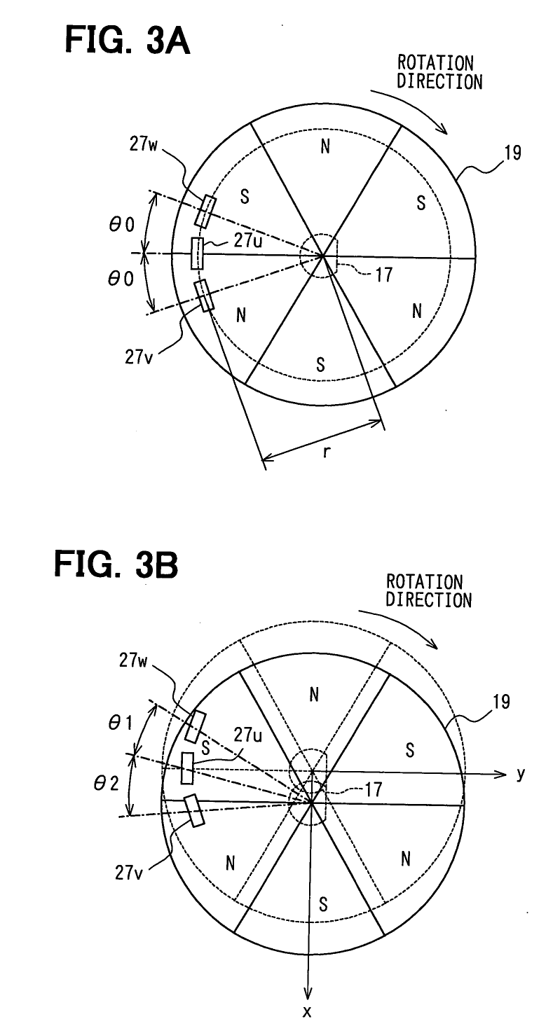

How the brushless motor operates is described below with reference to FIG. 3 to FIG. 6. In order for the power supply control circuit 23 to perform power supply switching control, position signals Du, Dv, and Dw must have a phase difference of 120 electrical degrees, which are obtained based on the output signals from the hole elements 27u, 27v, and 27w. To generate the position signals Du, Dv, and Dw using the phase adjusting means 28, the angles included between the hole elements 27w and 27u and between the hole elements 27u and 27v (hereinafter referred to as “layout angle θ”) around the output shaft 17 need to be one of the following mechanical angles: 20°, 40°, 80°, 100°, 140°, and 160°.

Applying this to a more general case, if the sensor magnet 19 and rotor magnet each have n poles, where n≧2, the layout angle θ can be expressed as the following equation (2), using a basic minimum angle θa obtained from the following equation (1). Since the hole elements 27u, 27v, and 27w are arranged in the range of 360°, it follows that the layout angle θ is less than 180°.

θa=360°/(n•3) (1)

θ=(3m+1)•θa and (3m+2)•θa (m is 0, 1, 2, 3, . . . ) (2)

The power supply control circuit 23 switches the power supply on and off to the switching elements of the inverter circuit 25 with a time delay of an electrical angle of 30°, using a timer, from the edges of the position signals Du, Dv, and Dw that are generated every electrical angle of 60°. Thus the excitation coils 14u, 14v, and 14w are supplied with a drive current by the three-phase power supply system, whereby a rotary magnetic field is created in the stator 12, which rotates the rotor 13 and the fan 18. The basis on which to determine the time delay in the switching of the power supply may be the average time of k periods (k≧2) immediately before the switching. For example, the average time of one turn of the rotor 13, instead of one period of 60° immediately before the switching.

The layout angle θ can variably be set as shown in equation (2) if consideration is given only to establishing a mutual phase difference of 120° between the detection signals Du, Dv, and Dw. In this embodiment, however, the layout angle θ is set to be 20° so as to minimize discrepancies in the phase difference between the detection signals Du, Dv, and Dw resulting from assembling errors of the brushless motor. The reason for thus setting the layout angle θ is explained below.

In the assembling of the brushless motor, the sensor magnet 19 is attached to the output shaft 17, while the hole elements 27u, 27v, and 27w are mounted on the circuit board 21, which is then attached to the motor holder 11. Thus, there are cases in which assembling errors accumulated through these assembling steps have some bearing on the relative positions of the sensor magnet 19 and hole elements 27u, 27v, and 27w. Such errors are within a permissible range of predetermined design tolerances, but cannot entirely be eliminated.

FIG. 3A shows the positional relationship between the sensor magnet 19 and hole elements 27u, 27v, and 27w when the hole elements 27u, 27v, and 27w are arranged at an ideal mechanical angle of θ0, which is 20° in this embodiment, around the output shaft 17. FIG. 3B shows the positional relationship between the sensor magnet 19 and hole elements 27u, 27v, and 27w that are displaced relative to each other because of assembling errors.

As can be seen from FIGS. 3A and 3B, because of the assembling errors, the angle θ1 included between the hole elements 27w and 27u around the output shaft 17 and the angle θ2 included between the hole elements 27u and 27v (hereinafter referred to as “layout angle θ1 and θ2”) are shifted from the angle θ0 that is ideal from a design point of view (hereinafter referred to as “ideal layout angle θ0”). When the sensor magnet 19 after the assembly is offset from an ideal position by Δx and Δy on an X-Y coordinate basis in FIG. 3B, approximate values of the layout angles θ1 and θ2 can be obtained from equations (3) to (6), in which r represents the distances from the output shaft 17 to the hole elements 27u, 27v, and 27w when the output shaft 17 is at the ideal location:

θ1≈θ0+Δθ1 (3)

θ2≈θ0+Δθ2 (4)

$$\begin{matrix}\begin{matrix}Δ θ1 = ( ⅆ θ 1 / ⅆ x ) \cdot Δ x + ( ⅆ θ 1 / ⅆ y ) \cdot Δ y \\ = \{ ( cos θ 0 - 1 ) \cdot ( 1 / r ) \} \cdot Δ x + \{ - sin θ 0 \cdot ( 1 / r ) \} \cdot Δ y\end{matrix} & ( 5 ) \\ \begin{matrix}Δ θ2 = ( ⅆ θ 2 / ⅆ x ) \cdot Δ x + ( ⅆ θ2 / ⅆ y ) \cdot Δ y \\ = \{ ( 1 - cos θ 0 ) \cdot ( 1 / r ) \} \cdot Δ x + \{ - sin θ 0 \cdot ( 1 / r ) \} \cdot Δ y\end{matrix} & ( 6 )\end{matrix}$$

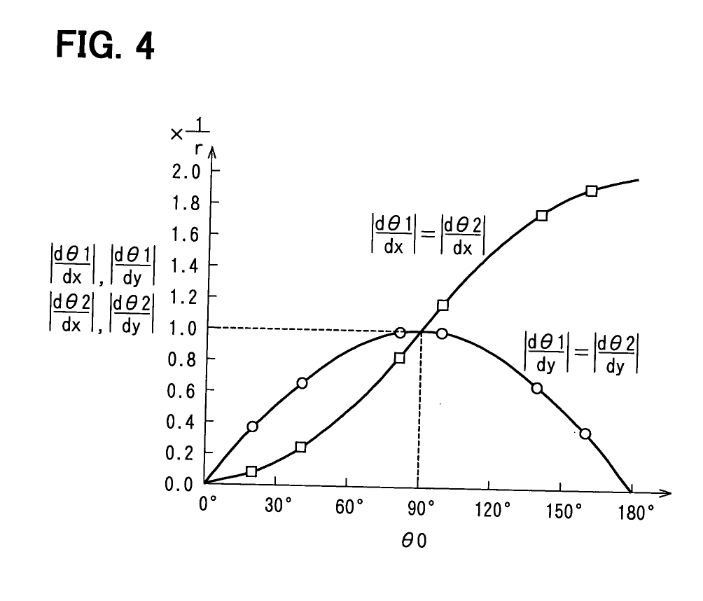

FIG. 4 shows the relationship between the coefficients |dθ1/dx|, |dθ1/dy|, |dθ2/dx|, and |dθ2/dy| in equations (3) to (6) and the ideal mechanical layout angles θ0 obtained by calculations. Coefficients |dθ1/dx| and |dθ2/dx| are equal, and they increase steadily in proportion to the ideal layout angle θ0. Coefficients |dθ1/dy| and |dθ2/dy| are equal, and they increase in proportion to the ideal layout angle θ0 in the range of from 0° to 90°, but then decrease after the angle θ0 exceeds 90°.

Substituting these coefficients in equations (5) and (6) reveals that respective displacement amounts Δθ1 and Δθ2 of the layout angles θ1 and θ2 become smaller with the decrease of the ideal layout angle θ0 in the range of under 90°, provided that the displacement amounts Δx and Δy are the same. In the range of over 90° of the ideal layout angle θ0, on the other hand, the displacement amounts Δθ1 and Δθ2 are heavily dependent on the displacement amounts Δx and Δy, because the coefficients |dθ1/dy| and |dθ2/dy| decrease while the coefficients |dθ1/dx| and |dθ2/dx| increase.

In actual applications, the hole elements 27u, 27v, and 27w need to be disposed away from the power supply terminals 24u, 24v, and 24w so as to avoid adverse effects of any magnetic field created by the supplied current. Thus, the ideal layout angle θ0 is normally set to be 90° or smaller. In this embodiment, therefore, based on the above calculation results, the hole elements 27u, 27v, and 27w are disposed with the minimum possible layout angle θ of 20° so as to minimize the displacement amounts Δθ1 and Δθ2 due to the assembling errors.

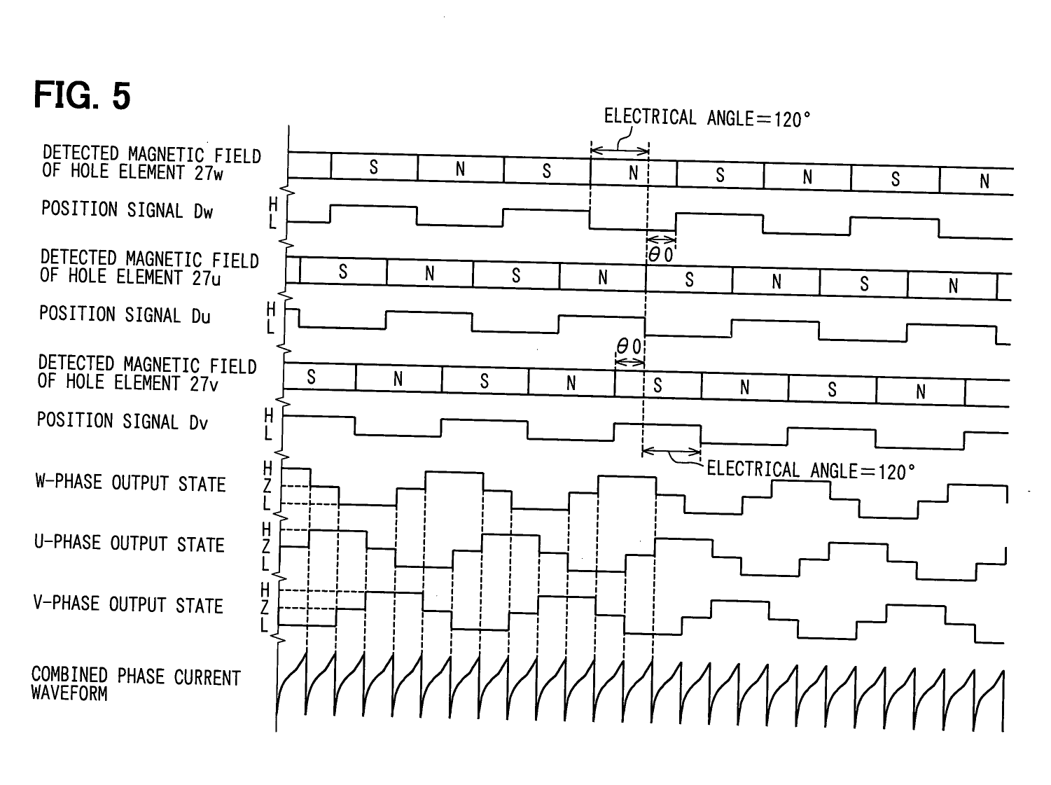

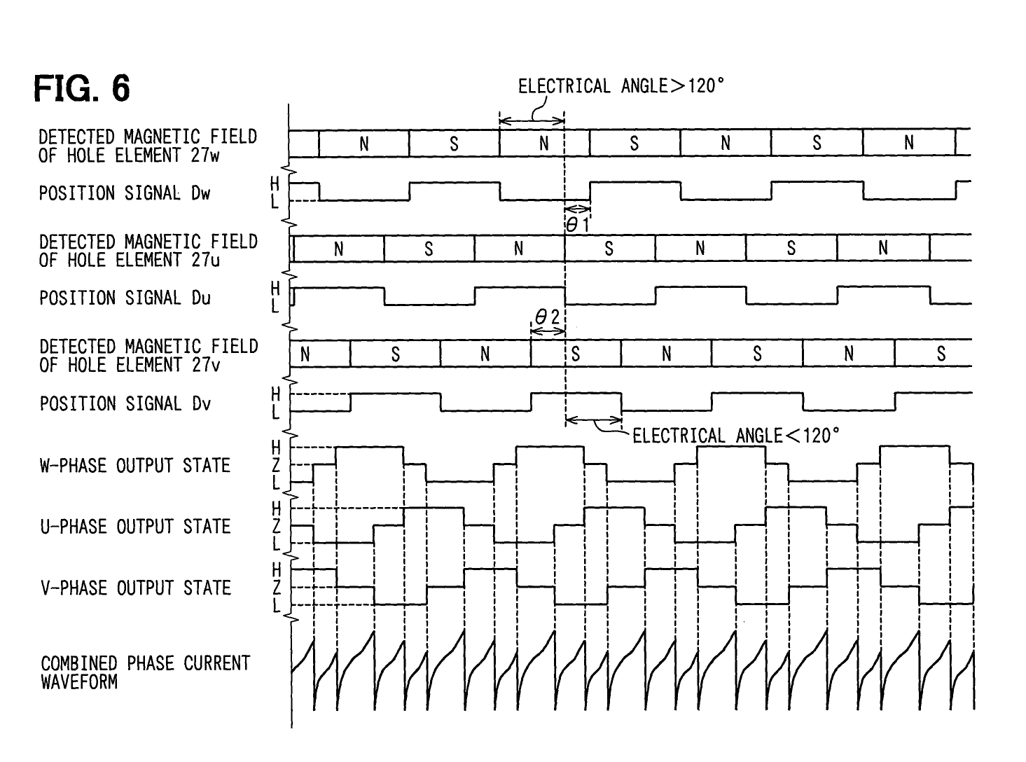

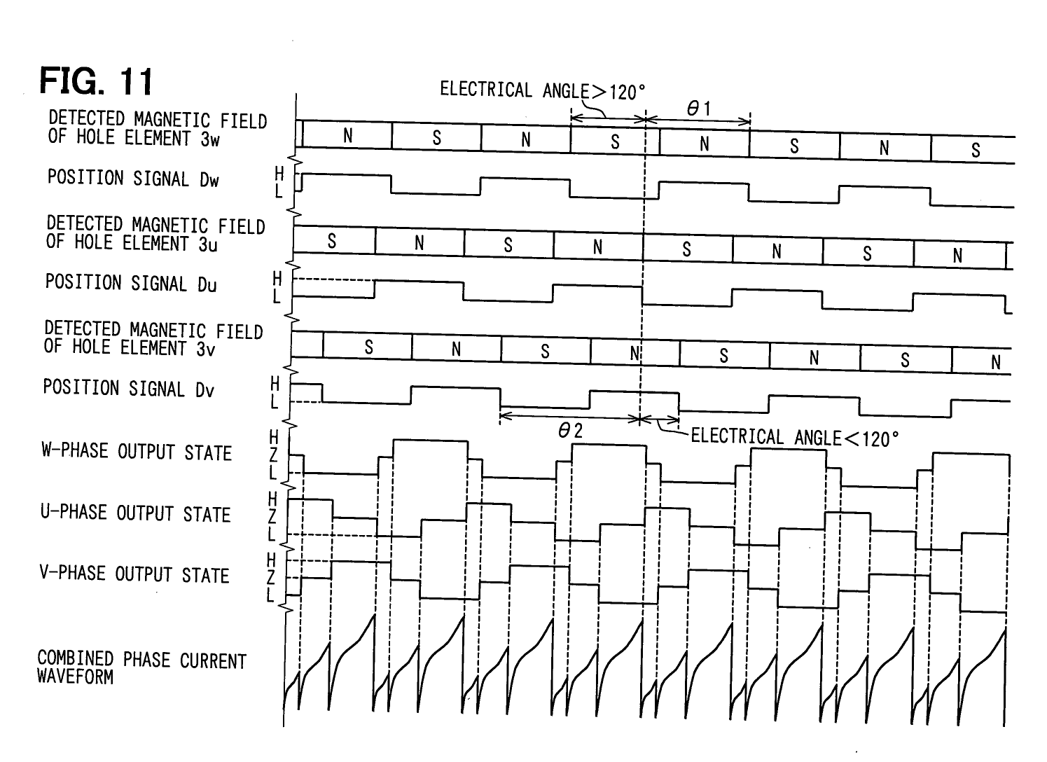

FIG. 5 and FIG. 6 are waveform charts. FIG. 5 illustrates a state in which the displacement amounts Δx and Δy are zero, whereas the latter illustrates a state in which the sensor magnet 19 has displaced in the X-axis direction and thus Δx>0, Δy=0. The displacement amount Δx in FIG. 11 which shows the case with the prior art is the same as that of FIG. 6. FIG. 5 and FIG. 6 illustrate the following:

(a) Magnetic field of the sensor magnet 19 detected by the hole element 27w;

(b) Position signal Dw;

(c) Magnetic field of the sensor magnet 19 detected by the hole element 27u;

(d) Position signal Du (e) Magnetic field of the sensor magnet 19 detected by the hole element 27v;

(f) Position signal Dv;

(g) W-phase output state of the inverter circuit 25;

(h) U-phase output state of the inverter circuit 25;

(i) V-phase output state of the inverter circuit 25; and

(j) Input current to the inverter circuit 25 (combined waveform of all the phase currents).

Output states of each phase (g) to (i) vary from one to another of the following:

H: Switching element on the upper arm side is turned on;

L: Switching element on the lower arm side is turned on;

Z: Switching elements on the upper and lower arm sides are both turned off.

If there are no assembling errors, the position signals Du, Dv, and Dw have a mutual phase difference of 120 electrical degrees as shown in FIG. 5, and the current waveforms in each phase are all identical, with the constant time slot of each period 60° of power supply during the constant speed drive. On the other hand, if there are assembling errors, because the layout angles θ1 and θ2 are shifted from 20°, the mutual phase difference between the position signals Du, Dv, and Dw becomes more than or less than 120°, whereby there are variations in the time slot of the power supply period even during constant speed drive, as shown in FIG. 6, resulting in discrepancies in the current waveforms in each phase. The power supply current thus has a superimposed component that varies in the cycle of 180 electrical degrees.

Nevertheless, a comparison between the brushless motor according to this embodiment in which the layout angles θ1 and θ2 are set to be 20° and the prior art brushless motor in which the layout angles θ1 and θ2 are set to be 80° clearly shows that the displacement amounts Δθ1 and Δθ2 when the sensor magnet 19 is offset are reduced to less than one third (see FIG. 4). Thereby, the discrepancies in phase difference between the position signals Du, Dv, and Dw can also be reduced, and generation of a current component that varies in the cycle of an electrical angle of 180° can be suppressed.

As described above, in the brushless motor of this embodiment, the layout angles θ1 and θ2 of the hole elements 27u, 27v, and 27w for detecting the magnetic field of the sensor magnet are set to be 20°, which is the minimum necessary angle for generating position signals Du, Dv, and Dw with a 120° phase difference. Thereby, even if there is a change in relative positions of the sensor magnet 19 and hole elements 27u, 27v, and 27w, the displacement amounts Δθ1 and Δθ2 of the layout angles θ1 and θ2 are suppressed to a minimum.

Accordingly, as compared to the prior art brushless motor in which no consideration is given to the effects of assembling errors on the displacement amounts Δθ1 and Δθ2 in relation to the arrangement of hole elements 27u, 27v, and 27w, discrepancies in phase difference between the position signals Du, Dv, and Dw are lessened, whereby the varying component superimposed in the phase currents is reduced. Torque variations are thereby diminished, and noise, vibration, and efficiency deterioration caused by resonance with the casing are all suppressed. Because the brushless motor is used as the blower motor of the vehicle air-conditioning system, suppression of noise is particularly advantageous in enhancing the comfort of the vehicle interior for the vehicle occupant.

The brushless motor of the present invention can be constructed by altering the layout of the hole elements 27u, 27v, and 27w on the circuit board 21 and by reversing the output terminals of the hole elements 27v and 27w of the prior art brushless motor, meaning that no additional components are necessary and no cost increase is involved. Since this alteration does not affect the phases of the position signals Du, Dv, and Dw representing the magnetic pole positions of the sensor magnet 19 and rotor magnet, the lead angle control in the prior art motor can also be performed without affecting driving efficiency.

### Second Embodiment

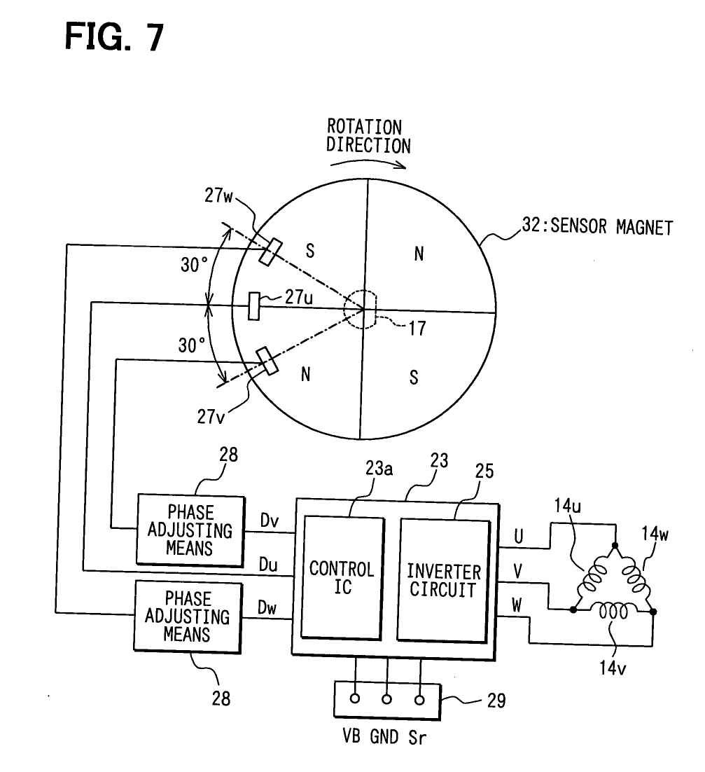

A second embodiment of the present invention will be described next with reference to FIG. 7, which provides a schematic representation of the electrical structure of the brushless motor. In this embodiment, the sensor magnet 32 and the rotor magnet are 4-pole magnets, unlike the previous embodiment with 6-pole magnets. The layout angle θ of the hole elements 27u, 27v, and 27w of this 4-pole magnet system should be one of the mechanical angles of 30°, 60°, 120°, or 150°, in accordance with the above equations (1) and (2). To minimize the displacement amounts Δθ1 and Δθ2 of the layout angles θ1 and θ2 resulting from assembling errors, 30° is the optimum angle. The same effects as those of the previous embodiment will thereby be achieved.

### Third Embodiment

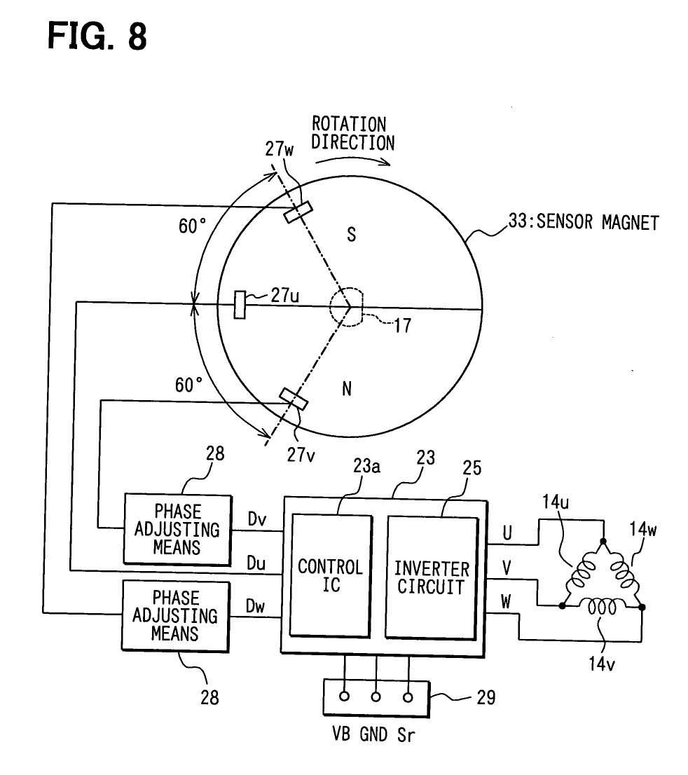

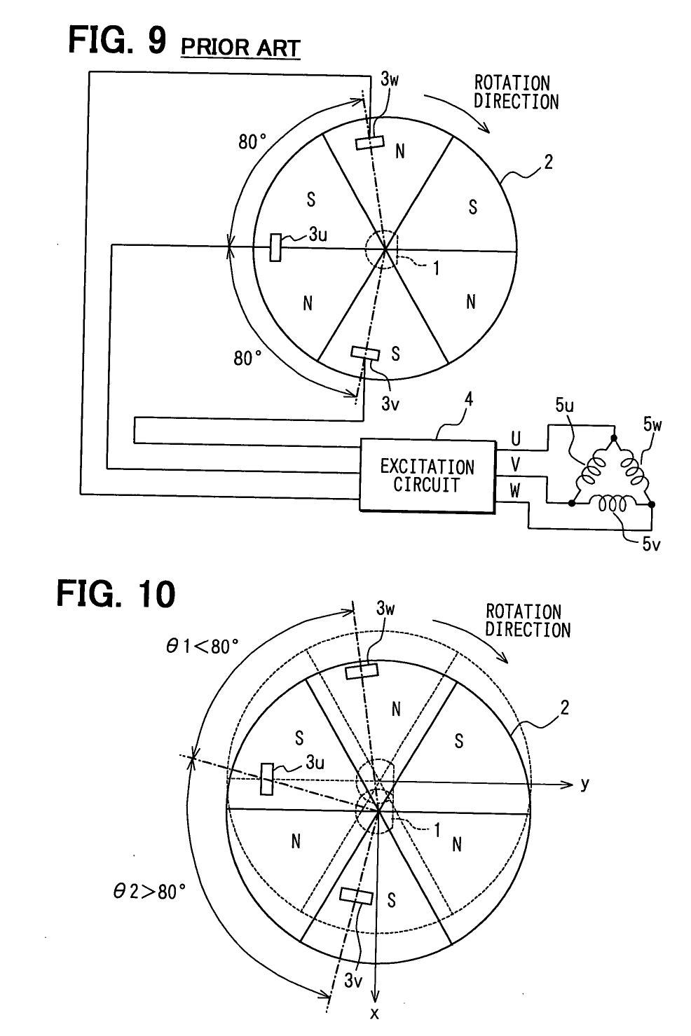

FIG. 8 illustrates a third embodiment of the present invention, which uses a 2-pole sensor magnet 33 and a rotor magnet. The layout angle θ of the hole elements 27u, 27v, and 27w of this 2-pole magnet system should be either one of the mechanical angles of 60° or 120°, in accordance with the above equations (1) and (2). To minimize the displacement amounts Δθ1 and Δθ2 of the layout angles θ1 and θ2 resulting from assembling errors, 60° is the optimum angle. The same effects as those of the previous embodiment will thereby be achieved.

### Other Embodiments

The present invention should not be limited to the embodiments described above and shown in the accompanying drawings and various modifications and extensions such as the following are possible.

Although the layout angle θ of the hole elements 27u, 27v, and 27w is set to be 20° in the first embodiment in accordance with the equations (1) to (6) and calculation results shown in FIG. 4, this is not an absolute requirement. If the layout of the circuit board 21 does not permit mounting of the hole elements with such a small angle spacing, then the layout angle θ may be selected from the options given above (40°, 80°, etc.) to be as small as possible. The same applies to the second and third embodiments.

For the magnetic sensors, other hole sensors such as hole ICs may be used in place of the hole elements. Magnetic resistance elements can also be used. The phase adjusting means 28 may include op-amps or inverters to achieve the phase inversion.

Position signals Du, Dv, and Dw having a mutual phase difference of 120 electrical degrees may be generated according to the following. If the mechanical layout angle θ1 or θ2 is one of θa, 5×θa, 7×θa, 11×θa, and so on (<180°), i.e., if the mechanical layout angle is (6m+3+/−2)×θa, where m is 0, 1, 2, . . . , the position signals Dv, Dw are obtained by inverting the phases of the output signals of the hole elements 27v and 27w. The output signal of the remaining hole element 27u is used as it is as the position signal Du. Alternatively, the output signals of the hole elements 27v and 27w may be used as position signals Dv and Dw, while the phase of the output signal of the hole element 27u is inverted to be used as the position signal Du.

The above brushless motor may not only be used as the blower motor of a vehicle air-conditioning system. The power control circuit 23 may be constructed as an external circuit of the brushless motor as part of an overall drive system including the brushless motor. The sensor magnets 19, 32, and 33 can be replaced by using rotor magnets instead, with the magnetic sensors directly detecting the magnetic field of the rotor magnet.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A brushless motor, comprising:
a stator with a plurality of sets of excitation coils therearound;
a rotor;
a sensor magnet having n poles (n≧2) rotated integrally with said rotor; and
a first magnetic sensor, a second magnetic sensor, and a third magnetic sensor, each for detecting a magnetic field of said sensor magnet, wherein
an angular distance between the first and second magnetic sensors, and an angular distance between the second and third magnetic sensors are set to be a smallest possible one of angles less than 180° that are obtained by
(3m+1)•θa and (3m+2)•θa, where m is an integer and equal to or larger than zero, and θa is a basic minimum mechanical angle obtained by 360°/(n•3).

2. The brushless motor according to claim 1, further comprising:
phase adjusting means for generating position signals having a mutual phase difference of electrical angle of 120° by adjusting phases of output signals from said first, second, and third magnetic sensors.

3. The brushless motor according to claim 2, wherein, when said angular distance of mechanical angle is one of the angles less than 180° that are obtained by (6m+3+/−2)•θa, said phase adjusting means inverts phases of output signals of said first and third magnetic sensors to produce position signals while using an output signal of said second magnetic sensor as a position signal without inverting its phase.

4. The brushless motor according to claim 2, wherein when said angular distance of mechanical angle is one of the angles less than 180° that are obtained by (6m+3+/−2)•θa, said phase adjusting means inverts the phase of an output signal of said second magnetic sensor to produce a position signal while using output signals of said first and third magnetic sensors as position signals without inverting their phases.

5. The brushless motor according to claim 3, wherein said first, second, and third magnetic sensors are hole elements, and said phase adjusting means performs phase inversion by reversely connecting signal output terminals of said hole elements.

6. The brushless motor according to claim 1, wherein said magnetic sensors and power supply terminals for said excitation coils are disposed upon a substrate, said substrate being assembled such that said magnetic sensors are positioned in close proximity to said sensor magnet.

7. The brushless motor according to claim 6, wherein said substrate includes a power supply control circuit mounted thereon for controlling power supplied to said excitation coils based on output signals from said magnetic sensors.

8. The brushless motor according to claim 1, wherein the brushless motor is used as a blower motor of a vehicle air-conditioning system.
